(19) United States
(12) Patent Application Publication
(10) Pub. No.: US 2008/0134272 A1
(43) Pub. Date: Jun. 5, 2008

(54) SERVICE PROVIDING SYSTEM AND APPLICATION EXECUTING METHOD EMPLOYING THE SAME

(76) Inventor: Toshihiko YASUMA, Atsugi-Shi (JP)

Correspondence Address: LADAS & PARRY LLP, 224 SOUTH MICHIGAN AVENUE, SUITE 1600, CHICAGO, IL, 60604, US

(21) Appl. No.: 11/939,620

(22) Filed: Nov. 14, 2007

(30) Foreign Application Priority Data
Dec. 5, 2006 (JP) 2006-328662

(51) Int. Cl. H04N 7/173

(52) U.S. Cl. 725/119

(57) ABSTRACT

A disclosed service providing system includes a server configured to deliver an image; and an image display terminal device configured to receive the image from the server via a communication network and display the image on a monitor. The server starts up and executes an application program at the server according to an operation made at the image display terminal device and sends, to the image display terminal device, the image obtained as a result of executing the application program. The image display terminal device displays the image received from the server on the monitor.

### BACKGROUND OF THE INVENTION

1. Field of the Invention

The present invention relates generally to service providing systems and application executing methods employing the same, and more particularly to a service providing system and an application executing method employing the same, in which video data delivered from a video delivery server via a network is received by an image displaying terminal device to display the video data on a television set.

2. Description of the Related Art

In recent years and continuing, content such as videos, music, and games can be downloaded from servers to personal computers via broadband lines such as ADSL (Asymmetric Digital Subscriber Line) and FTTH (Fiber To The Home). There have been developed information processing apparatuses such as IP-STB (IP-Set Top Box) and DMA (Digital Media Adaptor) for enabling users to easily view such content on household television sets (see, for example, Patent Documents 1 and 2).

These information processing apparatuses extract compressed video data and audio data from digital data acquired via a network, expand the extracted data, generate video signals and audio signals compatible with a household television set, and supply the signals to the household television set.

However, this image delivery system merely receives, with an image display terminal device, video data delivered from a video delivery server via a network, and displays the received data on a television set.

Incidentally, there has been developed a computer system in which a program executed by a computer can be remotely controlled by another computer by communicating via a network (see, for example, Patent Documents 3 and 4).

Patent Document 1: Japanese Laid-Open Patent Application No. 2001-129259

Patent Document 2: Japanese Laid-Open Patent Application No. 2000-115745

Patent Document 3: Japanese Laid-Open Patent Application No. H10-161885

Patent Document 4: Japanese Laid-Open Patent Application No. H05-35622

### SUMMARY OF THE INVENTION

The present invention provides a service providing system and an application executing method employing the same, in which one or more of the above-described disadvantages are eliminated.

A preferred embodiment of the present invention provides a service providing system capable of executing an application program using an image display terminal device and an application executing method employing the same.

An embodiment of the present invention provides a service providing system including a server configured to deliver an image; and an image display terminal device configured to receive the image from the server via a communication network and display the image on a monitor, wherein the server starts up and executes an application program at the server according to an operation made at the image display terminal device and sends, to the image display terminal device, the image obtained as a result of executing the application program; and the image display terminal device displays the image received from the server on the monitor.

An embodiment of the present invention provides a service providing system including an image delivery server configured to deliver an image; an image display terminal device configured to receive the image from the image delivery server via a communication network and display the image on a monitor; and an application program execution server configured to execute an application program; wherein the application program execution server starts up and executes the application program at the application program execution server according to an operation made at the image display terminal device and sends, to the image display terminal device, the image obtained as a result of executing the application program; and the image display terminal device displays the image received from the application program execution server on the monitor.

An embodiment of the present invention provides an application execution method employing an image display terminal device configured to receive, via a communication network, an image from an image delivery server configured to deliver the image, wherein the image display terminal device is further configured to display the image on a monitor, the application execution method including the steps of causing the image display terminal device to send a notification to the image delivery server to execute an application program; causing the image delivery server to start up and execute the application program according to the notification from the image display terminal device, and to send the image obtained as a result of executing the application program to the image display terminal device; and causing the image display terminal device to display, on the monitor, the image received from the image delivery server.

An embodiment of the present invention provides an application execution method employing an image display terminal device configured to receive, via a communication network, an image from an image delivery server configured to deliver the image, wherein the image display terminal device is further configured to display the image on a monitor, the application execution method including the steps of causing the image display terminal device to send a notification to an application program execution server to execute an application program; causing the application program execution server to start up and execute the application program according to the notification from the image display terminal device, and to send the image obtained as a result of executing the application program to the image display terminal device; and causing the image display terminal device to display, on the monitor, the image received from the application program execution server.

According to one embodiment of the present invention, a server processes an application program according to operational information received from an image display terminal device. An image obtained as a result of processing the application program is sent to the image display terminal device, and the image display terminal device displays the image. Accordingly, regardless of processing capabilities of the image display terminal device, the application program can be executed according to processing capabilities of the server. Furthermore, the image display terminal device can display the received image on a monitor in the same manner as in the conventional technology, and therefore, a high-level application program can be executed without making any particular changes in the image display terminal device.

### BRIEF DESCRIPTION OF THE DRAWINGS

Other objects, features and advantages of the present invention will become more apparent from the following detailed description when read in conjunction with the accompanying drawings, in which:

FIG. 1 is a configuration diagram of a system according to an embodiment of the present invention;

FIG. 2 is a block diagram of an image display terminal device;

FIG. 3 is block diagram of a video delivery server;

FIG. 4 is a flowchart of an application execution process performed by an image delivery system according to an embodiment of the present invention; and

FIG. 5 is a configuration diagram of a modification of the system according to an embodiment of the present invention.

### DETAILED DESCRIPTION OF THE PREFERRED EMBODIMENTS

A description is given, with reference to the accompanying drawings, of an embodiment of the present invention.

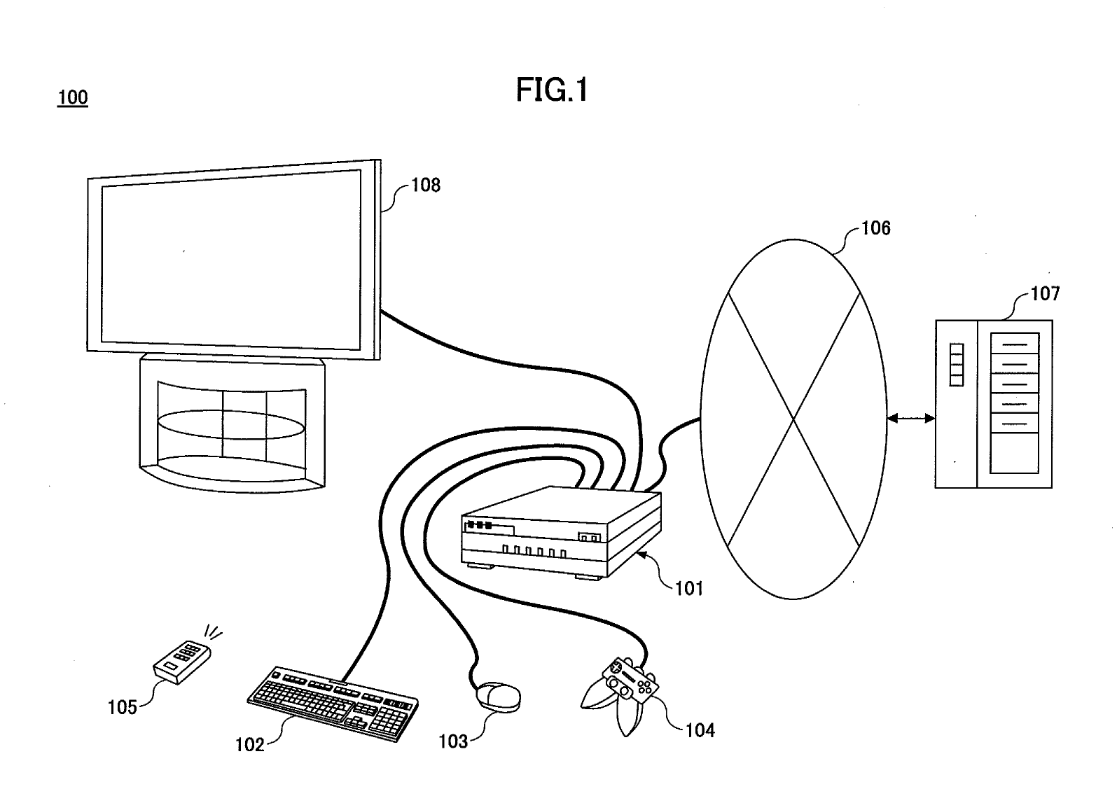

FIG. 1 is a configuration diagram of a system according to an embodiment of the present invention.

An image delivery system 100 according to an embodiment of the present invention includes an image display terminal device 101, a keyboard 102, a mouse 103, a game control pad 104, a remote controller 105, a network 106, and a video delivery server 107.

The image display terminal device 101 according to an embodiment of the present invention can be controlled by HIDs (Human Interface Device) such as the keyboard 102, the mouse 103, the game control pad 104, and the remote controller 105.

The image display terminal device 101 detects an operation of the keyboard 102, the mouse 103, the game control pad 104, or the remote controller 105, generates operational information (a command) corresponding to the detected operation, and sends the operational information to the video delivery server 107 via the network 106. The video delivery server 107 reads video data corresponding to the operational information received from the image display terminal device 101, compresses the video data, performs data processing on the video data such as scrambling, and delivers the video data to the image display terminal device 101 via the network 106.

When the video data is received from the video delivery server 107, which video data has been subjected to compression and scrambling at the video delivery server 107, the image display terminal device 101 executes processes such as a descrambling process and an expanding process on the video data, and generates video signals. The image display terminal device 101 supplies the generated video signals to a television set 108.

The television set 108 includes a display device such as CRT (cathode ray tube), LCD (liquid crystal display), or a plasma display, which display device displays on its screen the video signals received from the image display terminal device 101.

Next, a configuration of the image display terminal device 101 is described.

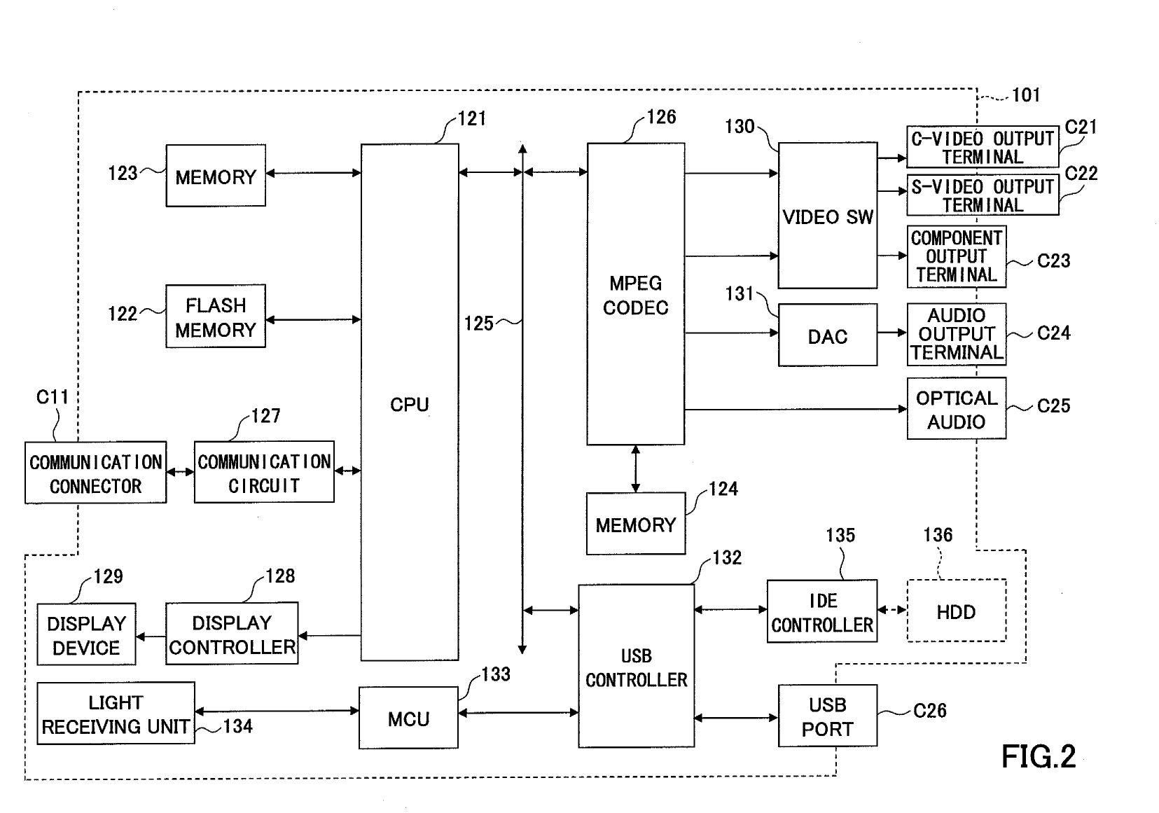

FIG. 2 is a block diagram of the image display terminal device 101.

The image display terminal device 101 includes a CPU (Central Processing Unit) 121, a flash memory 122, working memories 123 and 124, a PCI (Peripheral Component Interconnect) bus 125, an MPEG (Moving Picture Experts Group) codec 126, a communication circuit 127, a display controller 128, a display device 129, a video switch 130, a digital analog converter 131, a USB (Universal Serial Bus) controller 132, an MCU (Micro Control Unit) 133, a light receiving unit 134, an IDE (Integrated Device Electronics) controller 135, a communication connector C11, a composite video signal output terminal C21, a separate video signal output terminal C22, a component video signal output terminal C23, an audio signal output terminal C24, an optical audio signal output terminal C25, and a USB port C26.

The CPU 121 executes various processes according to firmware stored in the flash memory 122. The CPU 121 is connected to the working memory 123, the communication circuit 127, and the display controller 128, and is also connected to the MPEG codec 126 and the USB controller 132 via the PCI bus 125.

The flash memory 122 is, for example, a NOR-type flash memory, which stores the firmware. The working memory 123 is, for example, an SDRAM (Synchronous DRAM), which is connected to the CPU 121 and used as a working storage area for data processing executed by the CPU 121.

The working memory 124 is, for example, an SDRAM, which is connected to the MPEG codec 126 and used as a working storage area for data processing executed by the MPEG codec 126.

The PCI bus 125 is used for communication among the CPU 121, the MPEG codec 126, and the USB controller 132.

The MPEG codec 126 receives compressed data from the CPU 121 via the PCI bus 125. The MPEG codec 126 expands the compressed data received from the CPU 121 and decodes the data into video data and audio data. The MPEG codec 126 generates video signals from the decoded video data and outputs the video signals to the video switch 130.

The video signals generated at the MPEG codec 126 are output from the composite video signal output terminal C21, the separate video signal output terminal C22, or the component video signal output terminal C23, via the video switch 130. The composite video signal output terminal C21, the separate video signal output terminal C22, or the component video signal output terminal C23 is connected to the television set 108, and provides the video signals to the television set 108.

The composite video signal output terminal C21 outputs video signals in which brilliance signals, color signals, and synchronization signals are combined together. The separate video signal output terminal C22 outputs brilliance signals and color signals, separately. The component video signal output terminal C23 outputs brilliance signals, B-Y color-difference signals, and R-Y color-difference signals, separately. The B-Y color-difference signals and the R-Y color-difference signals are obtained by separating color signals according to their color components.

The audio data generated at the MPEG codec 126 is supplied to the digital analog converter 131. The digital analog converter 131 converts the audio data supplied from the MPEG codec 126 into analog audio signals.

The analog audio signals obtained by the conversion operation at the digital analog converter 131 are output from the audio signal output terminal C24. The MPEG codec 126 outputs optical audio signals to the optical audio signal output terminal C25.

The audio signal output terminal C24 or the optical audio signal output terminal C25 is, for example, connected to the television set 108 and supplies audio signals to the television set 108. The television set 108 drives a built-in speaker according to audio signals received from the audio signal output terminal C24 or the optical audio signal output terminal C25 to perform audio output.

The communication connector C11 is connected to a cable connected to the network 106, etc., to perform communication with the video delivery server 107.

The communication circuit 127 is connected between the CPU 121 and the communication connector C11 and controls communication between the network 106 and the CPU 121.

The display controller 128 controls the display device 129 according to instructions from the CPU 121 to display various types of information on the display device 129. The display device 129 is, for example, a 7-seg LED (Light Emitting Device) or an LCD (Liquid Crystal Display). The display device 129 displays various types of information by being controlled by the display controller 128.

The USB controller 132 is connected between the USB port C26 and the PCI bus 125 to act as an interface between the USB port C26 and the PCI bus 125. The keyboard 102, the mouse 103, the game control pad 104, etc., are connected to the USB port C26.

The USB controller 132 is connected to the MCU 133. The MCU 133 receives signals from the light receiving unit 134, generates input data, and supplies the input data to the USB controller 132. The USB controller 132 supplies the input data from the MCU 133 to the CPU 121.

The light receiving unit 134 converts the infrared light incident from the remote controller 105 into electric signals, and supplies the electric signals to the MCU 133. The MCU 133 analyzes the electric signals supplied by the light receiving unit 134, generates a command, and reports the command to the CPU 121 via the USB controller 132.

The USB controller 132 is connected to the IDE controller 135. The IDE controller 135 is a so-called ATA (AT Attachment) that is connected to an IDE device such as a hard disk drive 136. The IDE controller 135 acts as an interface between an IDE device such as the hard disk drive 136 and the USB controller 132.

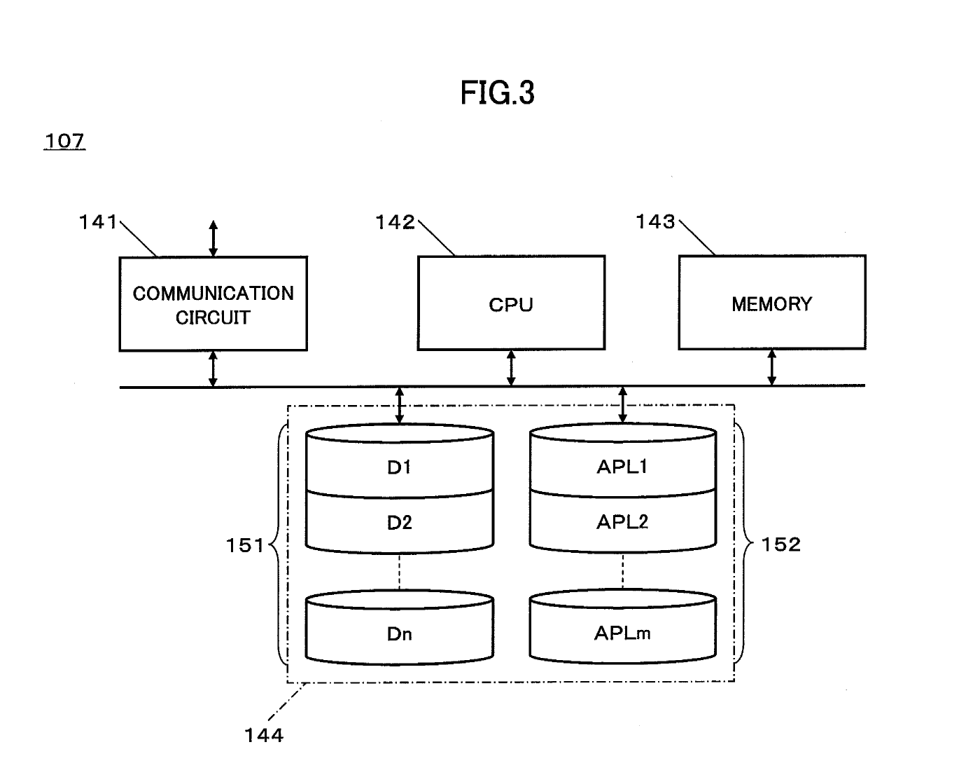

FIG. 3 is block diagram of the video delivery server 107.

The video delivery server 107 includes a communication circuit 141, a CPU 142, a memory 143, and a file device 144.

The communication circuit 141 is for performing communication with the image display terminal device 101 via the network 106.

The CPU 142 delivers video information to the image display terminal device 101 according to a command received from the image display terminal device 101, and also starts up and executes an application program and delivers only that page to the image display terminal device 101.

The memory 143 is, for example a RAM, which is used as a working storage area for the CPU 142.

The file device 144 primarily includes a video file unit 151 and an application program file unit 152.

The video file unit 151 stores plural sets of video data D1 through Dn. The video data D1 through Dn is read by the CPU 142 and delivered to the image display terminal device 101.

The application program file unit 152 stores application programs APL1 through APLm. The application programs APL1 through APLm are started up and executed by the CPU 142. The application programs APL1 through APLm include various types of software such as word processing software, spreadsheet software, image processing software, rendering software, and video processing software.

<Operations>

Next, operations of the image delivery system 100 according to an embodiment of the present invention are described.

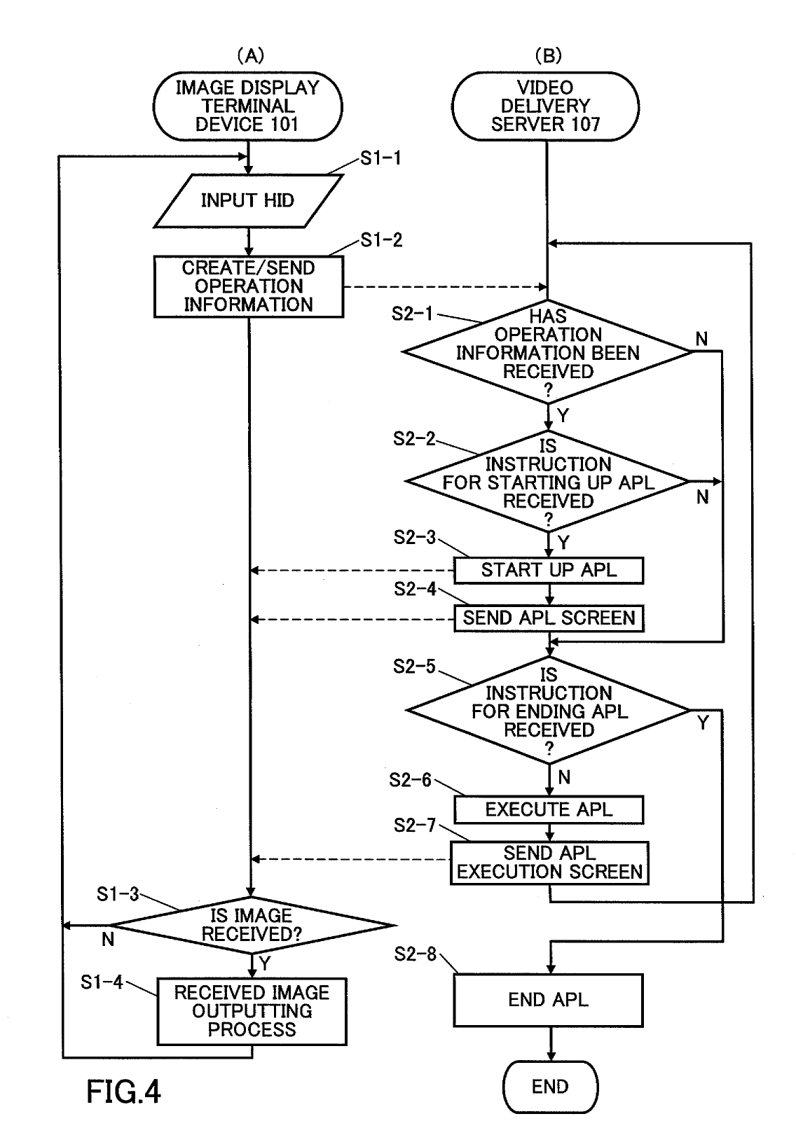

FIG. 4 is a flowchart of an application execution process performed by the image delivery system 100. In FIG. 4, (A) is a flowchart of a process performed by the image display terminal device 101 and (B) is a flowchart of a process performed by the video delivery server 107.

In step S1-1, when the HID is operated, such as the keyboard 102, the mouse 103, the game control pad 104, or the remote controller 105, in step S1-2, the image display terminal device 101 creates corresponding operational information and sends the created operational information to the video delivery server 107.

In step S2-1, when the operational information is received from the image display terminal device 101, in step S2-2, the video delivery server 107 determines whether the operational information is an instruction for starting up a predetermined application program APLi among the application programs APL1 through APLm stored in the application program file unit 152.

In step S2-2, when the operational information received from the image display terminal device 101 is information for starting up the application program APLi, in step S2-3, the video delivery server 107 starts up the application program APLi, and in step S2-4, the video delivery server 107 sends image information of that page to the image display terminal device 101.

In step S1-3, when the image information is received from the video delivery server 107, in step S1-4, the image display terminal device 101 performs a descrambling process and an expanding process on the received image information to obtain image signals, and supplies the image signals to the television set 108. The television set 108 displays the image signals received from the image display terminal device 101 on its screen.

In this manner, by operating a HID such as the keyboard 102, the mouse 103, the game control pad 104, or the remote controller 105, the page of the application program APLi can be displayed on the television set 108.

In step S2-2, when the operational information from the image display terminal device 101 is not for starting up the application program APLi, in step S2-5, the video delivery server 107 determines whether the operational information from the image display terminal device 101 is for ending the application program APLi.

In step S2-5, when the operational information from the image display terminal device 101 is not for ending the application program APLi, in step S2-6, the video delivery server 107 executes the application program APLi according to the operational information from the image display terminal device 101, and in step S2-7, the video delivery server 107 sends a page obtained by executing the application program APLi to the image display terminal device 101.

In step S1-3, when the image information is received from the video delivery server 107, in step S1-4, the image display terminal device 101 performs a descrambling process and an expanding process on the received image information to obtain image signals, supplies the image signals to the television set 108, and causes the television set 108 to display a page obtained as a result of executing the process corresponding to the operation made with the use of the HDI such as the keyboard 102, the mouse 103, the game control pad 104, or the remote controller 105.

By repeatedly operating the HID such as the keyboard 102, the mouse 103, the game control pad 104, or the remote controller 105 at the image display terminal device 101, it is possible to execute data processing of the application program APLi.

In step S2-5, when the operational information from the image display terminal device 101 is for ending the application program APLi, in step S2-8, the video delivery server 107 ends the application program APLi having been started up. In step S2-1, even if there is no operational information from the image display terminal device 101, the video delivery server 107 sends an operation page indicating that the application program APLi is now being executed, to the display terminal device 101. Accordingly, similar to the case of executing a regular application program with a personal computer, the image display terminal device 101 is shown an operation page indicating that the application program APLi is now being executed. Depending on the type of application program APLi being executed, the video delivery server 107 may end the application program APLi even when there is no operational information for ending the application program APLi from the image display terminal device 101 in step S2-1.

In this manner, according to an embodiment of the present invention, it is possible to execute the application program APLi being executed at the video delivery server 107 by operating it from the image display terminal device 101, and display the application program APLi information on the television set 108. Accordingly, it is possible to execute an application program by using the image display terminal device 101.

In substantially the same manner as conventional operations, the image display terminal device 101 only sends operational information to the video delivery server 107, receives an image from the video delivery server 107, and displays the received image on the television set 108. Therefore, the image display terminal device 101 can have substantially the same configuration as a conventional configuration.

According to an embodiment of the present invention, the application program is executed by the video delivery server 107, and therefore, the application program can be executed according to the processing capabilities of the video delivery server 107.

According to an embodiment of the present invention, the application program is executed by the video delivery server 107; however, a server for executing the application can be provided separately from the video delivery server 107.

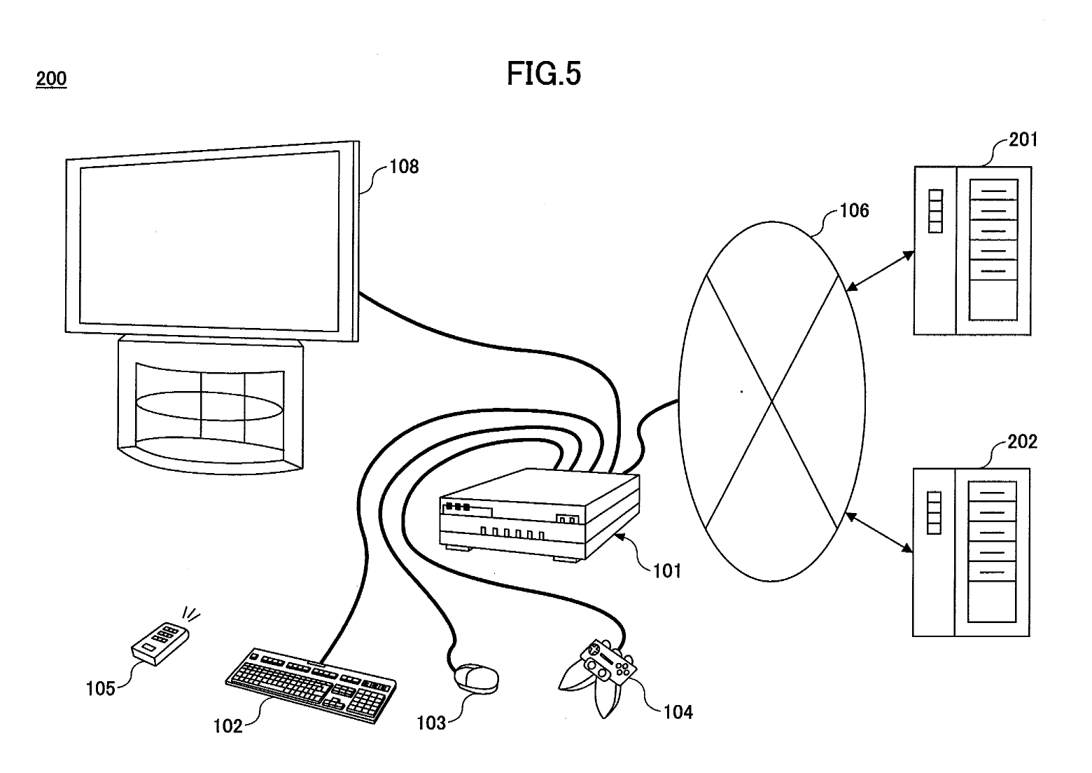

FIG. 5 is a configuration diagram of a modification of the system according to an embodiment of the present invention. In FIG. 5, elements corresponding to those in FIG. 1 are denoted by the same reference numbers, and are not further described.

A video delivery system 200 according to the modification includes a video delivery server 201 and an application program execution server 202. The video delivery server 201 reads a video according to an operation made with the use of an HID, such as the keyboard 102, the mouse 103, the game control pad 104, or the remote controller 105, and provides the video to the image display terminal device 101. The image display terminal device 101 causes the television set 108 to display the video received from the video delivery server 201.

The application program execution server 202 starts up and executes an application program according to an operation made with the use of an HID such as the keyboard 102, the mouse 103, the game control pad 104, or the remote controller 105 of the image display terminal device 101, and provides a page of the application program to the image display terminal device 101. When the image display terminal device 101 is to deliver a video, the image display terminal device 101 causes the television set 108 to display the video received from the video delivery server 201. When the image display terminal device 101 is to execute the application program, the image display terminal device 101 causes the television set 108 to display the page received from the application program execution server 202.

According to this modification, the application program is executed by the application program execution server 202, and therefore, it is possible to reduce the processing workload of the video delivery server 201 and the application program can be executed without interfering with the video delivery service.

The present invention is not limited to the specifically disclosed embodiment, and variations and modifications may be made without departing from the scope of the present invention.

The present application is based on Japanese Priority Patent Application No. 2006-328662, filed on Dec. 5, 2006, the entire contents of which are hereby incorporated by reference.

What is claimed is:

1. A service providing system comprising:
a server configured to deliver an image; and
an image display terminal device configured to receive the image from the server via a communication network and display the image on a monitor, wherein:
the server starts up and executes an application program at the server according to an operation made at the image display terminal device and sends, to the image display terminal device, the image obtained as a result of executing the application program; and
the image display terminal device displays the image received from the server on the monitor.

2. A service providing system comprising:
an image delivery server configured to deliver an image;
an image display terminal device configured to receive the image from the image delivery server via a communication network and display the image on a monitor; and
an application program execution server configured to execute an application program;
wherein:
the application program execution server starts up and executes the application program at the application program execution server according to an operation made at the image display terminal device and sends, to the image display terminal device, the image obtained as a result of executing the application program; and
the image display terminal device displays the image received from the application program execution server on the monitor.

3. An application execution method employing an image display terminal device configured to receive, via a communication network, an image from an image delivery server configured to deliver the image, wherein the image display terminal device is further configured to display the image on a monitor, the application execution method comprising the steps of:
causing the image display terminal device to send a notification to the image delivery server to execute an application program;
causing the image delivery server to start up and execute the application program according to the notification from the image display terminal device, and to send the image obtained as a result of executing the application program to the image display terminal device; and
causing the image display terminal device to display, on the monitor, the image received from the image delivery server.

4. An application execution method employing an image display terminal device configured to receive, via a communication network, an image from an image delivery server configured to deliver the image, wherein the image display terminal device is further configured to display the image on a monitor, the application execution method comprising the steps of:
causing the image display terminal device to send a notification to an application program execution server to execute an application program;
causing the application program execution server to start up and execute the application program according to the notification from the image display terminal device, and to send the image obtained as a result of executing the application program to the image display terminal device; and
causing the image display terminal device to display, on the monitor, the image received from the application program execution server.
